(19) United States
(12) Patent Application Publication
(10) Pub. No.: US 2020/0198410 A1
(43) Pub. Date: Jun. 25, 2020

(54) TIRE WITH INTEGRATED TREAD WEAR INDICATOR

(71) Applicant: The Goodyear Tire & Rubber Company, Akron, OH (US)

(72) Inventors: Max Harold Dixon, Kent, OH (US); John Kotanides, JR., Canton, OH (US); Christine Ann Demagall, Valley City, OH (US); Jesse Brian Serva, Akron, OH (US)

(21) Appl. No.: 16/227,548

(22) Filed: Dec. 20, 2018

(51) Int. Cl. B60C 11/24; B60C 11/03; B60C 11/13

(52) U.S. Cl. CPC B60C 11/24; B60C 11/0306; B60C 2011/0346; B60C 2011/1361; B60C 11/1353

(57) ABSTRACT

A tire including a tread wear indicator is provided. A first cutout is formed in a wall of a first selected tread element and faces a selected segment of a circumferential groove. A second cutout is formed in a wall of a second selected tread element and is opposite the first cutout. An indicator is formed in and extends across the selected circumferential groove segment and the first and second cutouts. The indicator includes a plurality of step elements descending from a radially outward surface of the tread toward the bottom of the groove segment. Each step element includes an axially-extending surface approximately parallel to and radially inward of the radially outward surface of the tread, and a radially-extending surface approximately perpendicular to the axially-extending surface. The axially-extending surface of each step element is formed with indicia that are visible before tire wear commences.

### FIELD OF THE INVENTION

The invention relates to pneumatic tires and to tread wear indicators for such tires. More particularly, the invention is directed to a tire with a visual tread wear indicator that is economical to form and is easy for a user to read and understand.

### BACKGROUND OF THE INVENTION

In the pneumatic tire art, it is known that, as the tread of the tire wears away, the ability to maintain traction may diminish on wet or snow-covered roads. Accordingly, once the tread is worn beyond a certain tread depth, the tire should be replaced to maintain adequate traction.

In order to inform a vehicle user when a tire may need to be replaced due to tread wear, prior art tread wear indicators were developed. For example, some tread wear indicators involved providing features molded into locations on the tire tread that undesirably interfered with the flow of water and materials, or undesirably affected tread performance. In addition, many such prior art indicators have been difficult for a user to see. An additional disadvantage of certain prior art indicators has been a configuration that wore away before the user saw or understood the wear indication.

Still other indicators were developed that involved electronic sensors which measure tire wear and provided an alert or signal to the user as to the wear state of the tire. While such sensors have been suitable for their intended purpose, they unnecessarily add to the cost and complexity of the tire.

As a result, there is a need in the art for a tire with a tread wear indicator that is easy for a user to see, does not interfere with tire performance, and is economical to form and use.

### SUMMARY OF THE INVENTION

According to an aspect of an exemplary embodiment of the invention, a tire includes a tread wear indicator. The tire includes a pair of sidewalls extending to a tread, and the tread includes a plurality of tread elements and a plurality of angular circumferential grooves, in which the grooves are comprised of circumferential groove segments. The tread wear indicator includes a first cutout formed in a wall of a first selected tread element, in which the first cutout faces a selected one of the circumferential groove segments. A second cutout is formed in a wall of a second selected tread element. The second cutout faces the selected circumferential groove segment and is opposite the first cutout. An indicator is formed in and extends across the selected circumferential groove segment and the first and second cutouts. The indicator includes a plurality of step elements descending from a radially outward surface of the tread toward the bottom of the selected circumferential groove segment. Each step element includes an axially-extending surface that is approximately parallel to and radially inward of the radially outward surface of the tread, and a radially-extending surface that extends approximately perpendicular to the axially-extending surface. The axially-extending surface of each step element is formed with indicia, which are all visible to a user of the tire from a radially outward direction before wear of the tire commences.

### Definitions

The following definitions are applicable to the present invention.

“Axial” and “axially” mean lines or directions that are parallel to the axis of rotation of the tire.

“Circumferential” means lines or directions extending along the perimeter of the surface of the annular tread perpendicular to the axial direction.

“Equatorial plane” means the plane perpendicular to the axis of rotation of the tire and passing through the center of the tire tread.

“Footprint” means the contact patch or area of contact created by the tire tread with a flat surface as the tire rotates or rolls.

“Groove” means an elongated void area in a tread that may extend in a circumferential, lateral or angled manner about the tread in a straight, curved, or zigzag configuration.

“Inboard side” means the side of the tire nearest the vehicle when the tire is mounted on a wheel and the wheel is mounted on the vehicle.

“Inner” means toward the inside of the tire.

“Lateral” and “laterally” are used to indicate axial directions across the tread of the tire.

“Outboard side” means the side of the tire farthest away from the vehicle when the tire is mounted on a wheel and the wheel is mounted on the vehicle.

“Outer” means toward the outside of the tire.

“Radial” and “radially” are used to mean directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Tread” means a molded rubber component which includes that portion of the tire that comes into contact with the road when the tire is normally inflated and under normal load. The tread has a depth conventionally measured from the tread outer surface to the bottom of the deepest groove of the tire.

“Tread element” or “traction element” means a rib or a block element defined by a shape having adjacent grooves.

### BRIEF DESCRIPTION OF THE DRAWINGS

The invention will be described by way of example and with reference to the accompanying drawings, in which:

FIG. 1 is a fragmentary perspective view of a tire including an exemplary embodiment of the tread wear indicator of the present invention;

FIG. 2 is an enlarged fragmentary perspective view of the tire and tread wear indicator from the circled area shown in FIG. 1;

FIG. 3 is a fragmentary plan view of the tire and tread wear indicator shown in FIG. 1; and

FIG. 4 is a cross-sectional view of the tire and tread wear indicator taken along line 4-4 in FIG. 3.

Similar numerals refer to similar parts throughout the drawings.

### DETAILED DESCRIPTION OF THE INVENTION

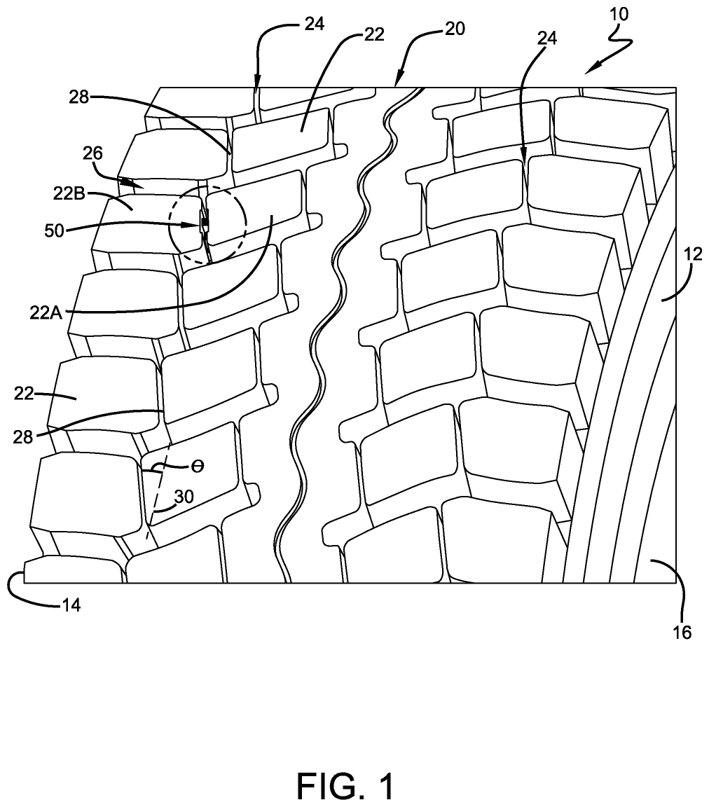

Turning to FIG. 1, an exemplary tire is indicated at 10 and includes a pair of sidewalls 12 and 14 extending from respective bead areas 16 (only one shown) to a tread 20. The tread 20 includes a plurality of tread elements 22 that are defined by angular circumferential grooves 24 and angular lateral grooves 26. More particularly, each angular circumferential groove 24 extends about the tire 10 in a circumferential manner according to segments 28 that extend at an angle θ relative to a circumferential direction 30 of the tread 20. The angle θ may be from about 10 degrees to about 30 degrees relative to a circumferential direction 30 of the tread 20. The circumferential groove segments 28 are defined by respective segments 32 of each lateral groove 26. In this manner, the tread elements 22 are angled relative to one another.

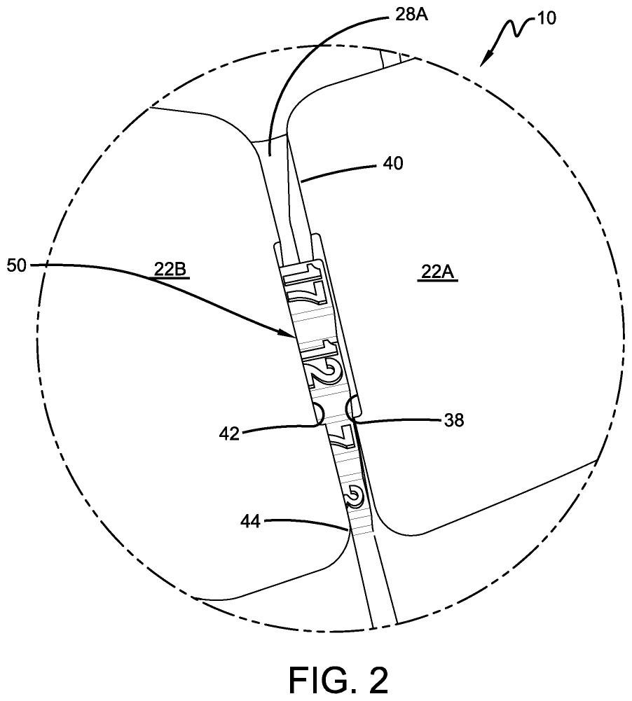

As shown in FIG. 2, a selected one of the circumferential groove segments 28A extends between a first selected tread element 22A and a second selected tread element 22B. The first selected tread element 22A includes a first cutout 38 in a wall 40 facing the selected circumferential groove segment 28A. The second selected tread element 22B includes a second cutout 42 in a wall 42 facing the selected circumferential groove segment 28A and being opposite the first cutout 38.

An exemplary embodiment of the tread wear indicator of the present invention is indicated generally at 50. The tread wear indicator is disposed in the selected circumferential groove segment 28A and extends into the first cutout 38 and the second cutout 42. It is to be understood that the tread wear indicator 50 may be formed in any one of the circumferential groove segments 28 and corresponding tread elements 22 formed with cutouts 38 and 42. In addition, the tire 10 may include more than one tread wear indicator 50.

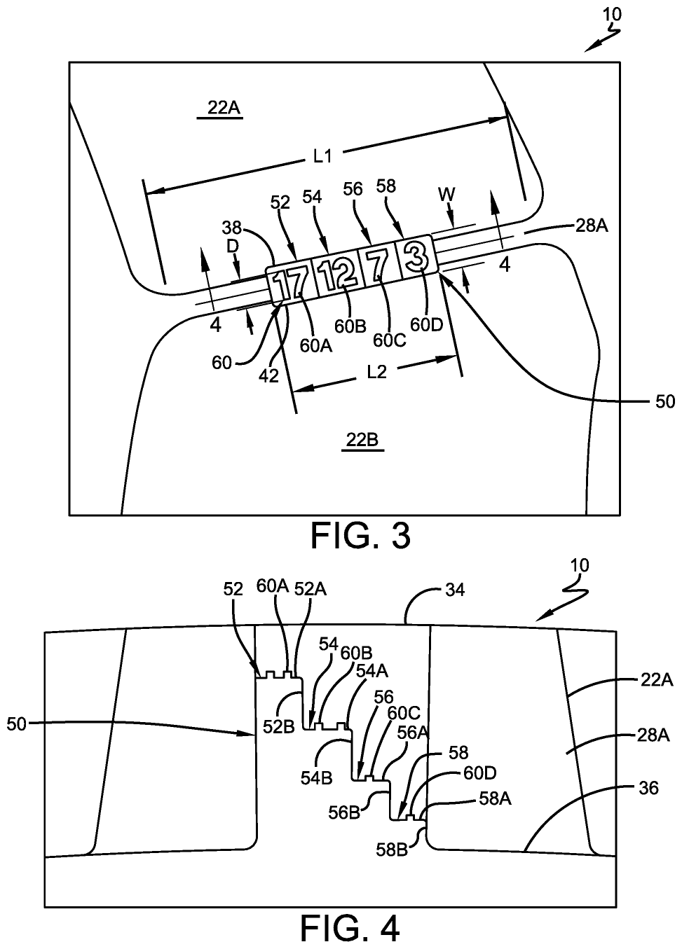

With reference to FIG. 3, the tread wear indicator 50 extends completely across the selected circumferential groove segment 28A and the cutout 38 formed in the first selected tread element 22A and the cutout 42 formed in the second selected tread element 22B. More particularly, the tread wear indicator 50 is of a width W, which is the same width of the combined selected circumferential groove segment 28A and the first and second cutouts 38 and 42. In addition, the selected circumferential groove segment 28A is formed with a length L1. The tread wear indicator 50 is formed with a length L2, which is less than about 80 percent of the selected groove segment length L1. By being of the large width W, the tread wear indicator 50 is prominent and easy to read.

With additional reference to FIG. 4, the tread wear indicator 50 preferably is formed with a staircase configuration. More particularly, a plurality of step elements descends from a radially outward surface 34 of the tread 20 toward a bottom or radially inward surface 36 of the selected circumferential groove segment 28A. The tread wear indicator 50 includes at least two elements, and preferably four or more elements. As will be described below, each element is similar to the other elements in shape and configuration.

For example, a first step element 52 includes an axially-extending surface 52A that is approximately parallel to and radially inward of the outward tread surface 34. Preferably, the axially-extending surface 52A is formed with a square or rectangular shape. A radially-extending surface 52B extends from the axially-extending surface 52A in an approximately perpendicular manner.

A second step element 54 includes an axially-extending surface 54A that is parallel to and radially inward of the axially-extending surface 52A of the first step element 52. Preferably, the axially-extending surface 54A is formed with a square or rectangular shape. A radially-extending surface 54B extends from the axially-extending surface 54A in an approximately perpendicular manner.

A third step element 56 includes an axially-extending surface 56A that is parallel to and radially inward of the axially-extending surface 54A of the second step element 54. Preferably, the axially-extending surface 56A is formed with a square or rectangular shape. A radially-extending surface 56B extends from the axially-extending surface 56A in an approximately perpendicular manner.

A fourth step element 58 includes an axially-extending surface 58A that is parallel to and radially inward of the axially-extending surface 56A of the third step element 56. Preferably, the axially-extending surface 58A is formed with a square or rectangular shape. A radially-extending surface 58B extends from the axially-extending surface 58A to the bottom 36 of the selected circumferential groove segment 28A in an approximately perpendicular manner.

The height of each one of the step elements 52, 54, 56 and 58 is based upon the number of steps and the minimum desired indicator height employed for a particular configuration of the tread wear indicator 50. For example, the axially-extending surface 58A of the bottom step element 58 preferably is at a minimum desired indicator height. This height may correspond to a recommended minimum tread depth and is based upon particular design considerations for the tire 10.

The axially-extending surface 58A of the bottom step element 58 may thus be considered to be zero percent of the recommended tread height, while the new, unworn surface 34 of the tread 20 may be considered to be 100 percent of the recommended tread height. Each step element 52, 54, 56 and 58 thus is at a set height which corresponds to a specific percentage of the recommended tread height. For example, the axially-extending surface 52A of the first step element 52 may be at a height that corresponds to 75 percent of the difference between the height of the axially-extending surface 58A of the fourth step element 58A and the unworn tread surface 34. The axially-extending surface 58A of the first step element 58 may thus indicate a level or height at which 75 percent of the recommended tread height remains.

The axially-extending surface 54A of the second step element 54 may be at a height that corresponds to 50 percent of the difference between the height of the axially-extending surface 58A of the fourth step element 58 and the unworn tread surface 54. The axially-extending surface 54A of the second step element 54 may thus indicate a level or height at which 50 percent of the recommended tread height remains.

The axially-extending surface 56A of the third step element 56 may be at a height that corresponds to 25 percent of the difference between the height of the axially-extending surface 58A of the fourth step element 58 and the unworn tread surface 34. The axially-extending surface 56A of the third step element 56 may thus indicate a level or height at which 25 percent of the recommended tread height remains.

As described above, the axially-extending surface 58A of the fourth step element 58 may indicate a height at which 0 percent of the recommended tread height remains and tire replacement should occur.

Each step element 52, 54, 56 and 58 preferably is formed with indicia 60 for easy identification by a user. For example, the axially-extending surface 52A of the first step element 52 preferably is formed with a first number 60A, which is easily seen by a user. The axially-extending surface 54A of the second step element 54 preferably is formed with a second number 60B. The axially-extending surface 56A of the third step element 56 preferably is formed with a third number 60C. The axially-extending surface 58A of the fourth step element 58 preferably is formed with a fourth number 60D.

The indicia 60 are formed with a distance across the width W of the tread wear indicator 50, which is designated in FIG. 3 as D. Preferably, the distance D is from about 80 percent to about 100 percent of the width W of the tread wear indicator 50. In addition, the first number 60A is the highest of the indicia 60, the second number 60B is the second highest, the third number 60C is the third highest and the fourth number 60D is the lowest. Preferably, each indicia 60A, 60B, 60C and 60D corresponds to a remaining tread depth in millimeters or 32nds of an inch. The use of such clear number-based indicia 60 as described above allows a “countdown” of the remaining tread life of the tire 10, which provides an indicator that is easy for a user to see and understand. It is to be understood that the indicia 60 can be changed to different numbers or characters, depending on particular design considerations.

By being formed in the selected circumferential groove segment 28A, the tread wear indicator 50 is easy for a user to see. Also, the tread wear indicator 50 follows the contour of the selected circumferential groove segment 28A and does not interfere with the performance of the tread 20. Moreover, the tread wear indicator 50 is economical to form.

For example, the tread wear indicator 50 preferably is formed in the tire 10 when the tire is cured. As is known in the art, the tire 10 is cured in a mold (not shown). During curing, the tread 20 is formed. To form the tread wear indicator 50, a die insert is formed with the above-described features of the tread wear indicator. The die insert is disposed in a corresponding opening formed in the tire curing mold, and when the tread 20 is formed on the tire 10 during curing, the tread wear indicator 50 is also formed. The die insert may be 3D printed, cast or fabricated, and may be formed of any suitable mold material, including steel, aluminum and alloys thereof.

The present invention also includes a method of forming a tread wear indicator 50 in a tire 10 and a method of using a tread wear indicator in a tire. Each method includes steps in accordance with the description that is presented above and shown in FIGS. 1 through 4.

It is to be understood that the structure of the above-described tread wear indicator 50 may be altered or rearranged, or components or steps known to those skilled in the art omitted or added, without affecting the overall concept or operation of the invention. For example, arrangements or configurations for the step elements 52, 54, 56 and 58 or indicia 60 other than those described above may be employed without affecting the overall concept or operation of the invention. In addition, the tread wear indicator 50 may be formed in any one of the circumferential groove segments 28 and the tread elements 22, and the tire 10 may include more than one tread wear indicator disposed in different locations and/or alignments.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A tire including a tread wear indicator, wherein the tire includes a pair of sidewalls extending to a tread, and the tread includes a plurality of tread elements and a plurality of angular circumferential grooves, the grooves being comprised of circumferential groove segments, the tread wear indicator comprising:
a first cutout formed in a wall of a first selected tread element, the first cutout facing a selected one of the circumferential groove segments;
a second cutout formed in a wall of a second selected tread element, the second cutout facing the selected circumferential groove segment and being opposite the first cutout;
an indicator being formed in and extending across the selected circumferential groove segment and the first and second cutouts;
the indicator including a plurality of step elements descending from a radially outward surface of the tread toward the bottom of the selected circumferential groove segment;
each step element including an axially-extending surface being approximately parallel to and being radially inward of the radially outward surface of the tread, and a radially-extending surface extending approximately perpendicular to the axially-extending surface; and
the axially-extending surface of each step element being formed with indicia, wherein all of the indicia are visible to a user of the tire from a radially outward direction before wear of the tire commences.

2. The tire including a tread wear indicator of claim 1, wherein the indicator is formed with a length that is less than about 80 percent of a length of the selected groove segment.

3. The tire including a tread wear indicator of claim 1, wherein the circumferential groove segments extend at an angle relative to a circumferential direction of the tread, the angle being from about 10 degrees to about 30 degrees relative to a circumferential direction of the tread.

4. The tire including a tread wear indicator of claim 1, wherein the indicia are formed with a distance across a width of the tread wear indicator that is from about 80 percent to about 100 percent of the width of the tread wear indicator.

5. The tire including a tread wear indicator of claim 1, wherein the plurality of step elements are formed in a staircase configuration.

6. The tire including a tread wear indicator of claim 1, wherein the axially-extending surface of each step element includes a square or rectangular shape.

7. The tire including a tread wear indicator of claim 1, wherein the indicator includes at least four step elements.

8. The tire including a tread wear indicator of claim 1, wherein the axially-extending surface of each step element is disposed at a height that corresponds to a selected percentage of a recommended tread height.

9. The tire including a tread wear indicator of claim 8, wherein the axially-extending surface of a first one of the step elements is disposed at a height that corresponds to about 75 percent of a recommended tread height, the axially-extending surface of a second one of the step elements is disposed at a height that corresponds to about 50 percent of the recommended tread height, the axially-extending surface of a third one of the step elements is disposed at a height that corresponds to about 25 percent of the recommended tread height, and the axially-extending surface of a fourth one of the step elements is disposed at a height that corresponds to about zero percent of the recommended tread height.

10. The tire including a tread wear indicator of claim 1, further comprising a plurality of indicators, each one of said indicators being formed in a respective set of first and second selected tread elements and selected circumferential groove segment.

11. The tire including a tread wear indicator of claim 1, wherein the indicator is formed with an insert that is disposed in a mold which cures the tire.
